(19) United States
(12) Patent Application Publication
(10) Pub. No.: US 2006/0232536 A1
(43) Pub. Date: Oct. 19, 2006

(54) Dual Select Diode Active Matrix Liquid Crystal Display Employing In-Plane Switching Mode

(75) Inventor: Willem den Boer, Hillsboro, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: ScanVue Technologies,L.L.C., Hillsboro, OR (US)

(21) Appl. No.: 11/379,199

(22) Filed: Apr. 18, 2006

Related U.S. Application Data
(60) Provisional application No. 60/673,004, filed on Apr. 19, 2005.
(60) Provisional application No. 60/705,095, filed on Aug. 2, 2005.

(51) Int. Cl. G09G 3/36

(52) U.S. Cl. 345/91

(57) ABSTRACT

A pixel circuit. The pixel circuit includes a dual select diode arrangement configured for an in-plane switching mode of operation.

### CROSS REFERENCE TO RELATED APPLICATIONS

This application claims the benefit of U.S. Provisional Application No. 60/673,004, filed Apr. 19, 2005 and U.S. Provisional Application No. 60/705,095, filed Aug. 2, 2005. The entirety of each of the above listed documents is hereby incorporated herein by reference for all purposes.

### BACKGROUND AND SUMMARY

Liquid crystal display (LCD) technology provides relatively energy efficient, space efficient, high image quality displays. Such displays can be used on devices as small as a wrist watch or as large as a multimedia theater display. However, the inventor herein has recognized that current LCD technology is relatively expensive and/or can be difficult to scale to large sizes. These issues can be addressed by a dual select diode technology that utilizes in-plane switching and/or color-on-array designs.

### BRIEF DESCRIPTION OF THE DRAWINGS

FIG. 1 schematically shows six pixels of a dual select diode circuit.

FIG. 2 schematically shows six pixels of a dual select diode circuit adapted to employ in-plane switching.

FIG. 3 graphically shows exemplary current-voltage characteristics of diode and storage capacitor with operating regimes for the diode switch and the storage capacitor.

FIGS. 4a-4c schematically show an exemplary process for forming an in-plane switching dual select diode circuit.

FIG. 5 schematically shows an exemplary line inversion drive method.

FIG. 6 schematically shows an exemplary layout of six subpixels in an in-plane switching dual select diode liquid crystal display configured for a line inversion drive method.

FIG. 7 schematically shows six pixels in an exemplary dual select diode liquid crystal display configured for an in-plane switching mode.

FIG. 8 schematically shows an exemplary pseudo-dot inversion drive method.

FIG. 9 schematically shows six pixels in an exemplary dual select diode liquid crystal display configured for an in-plane switching mode.

FIGS. 10a-10 schematically show an exemplary process for forming an in-plane switching dual select diode circuit.

### WRITTEN DESCRIPTION

Thin Film Diode (TFD) Liquid Crystal Displays with two select lines per row of pixels can be used in a variety of display applications. When operated in a dual select mode, the pixel circuit can act as an analog switch. This can lead to a performance similar to TFT LCDs, as a result of accurate gray shade control, fast response time, and tolerance for variations in the Thin Film Diode characteristics over time and across the viewing area. Such a Dual Select Diode (DSD) LCD also can be relatively insensitive to RC delays on the select and data lines and can therefore be scaled up to very large area, exceeding 40 in. in diagonal size, for application in LCD TV.

Dual Select Diode (DSD) LCDs can use a two branch diode circuit which can accurately transfer the data voltage to the LC capacitor. Select lines can be located on the active array substrate and data lines on the opposite substrate.

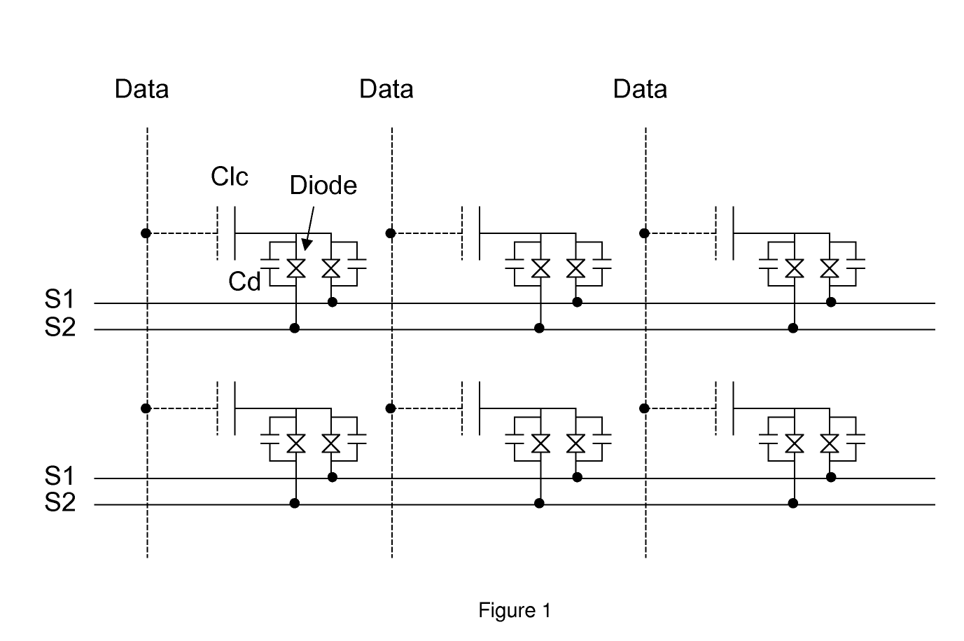

FIG. 1 shows a circuit diagram of 6 subpixels in a DSD AMLCD. CIc is the LC capacitance, Cd is the diode capacitance. S1 and S2 are the two select lines receiving opposite polarity select pulses. The dotted lines indicate the data lines on the opposite substrate, which can include the color filters.

The configuration shown in FIG. 1 is compatible with the conventional Twisted Nematic (TN) LC mode and also with the Multi-Domain Vertical Alignment (MVA) mode.

Although the conventional DSD AMLCD can be suitable for many display applications, additional improvements in performance and/or cost can increase the applications in which the technology beats competitive technologies. The following are nonlimiting examples of improvements attainable by the technology of the present disclosure:

1) Improve viewing angle as compared to conventional TN mode; 2) Minimize the total combined mask count and process steps for the active array substrate and the top substrate of the LCD; 3) Add a storage capacitance at each pixel to improve gray scale control; 4) Eliminate all patterning steps on the top substrate, so that there is no critical alignment between the two substrates in large area manufacturing (on e.g. ˜2 m×2 m substrates); 5) Minimize RC delays on the buslines so as to improve the possible size of the DSD LCD.

Another LC mode, the In-Plane-Switching (IPS) mode, can give superior viewing angle behavior, as compared to the conventional Twisted Nematic (TN) mode. In the IPS mode, the electrodes controlling the LC orientation can all be on the active matrix substrate. When a voltage is applied between these lateral electrodes, the resulting lateral field causes the LC molecules to rotate parallel to the glass substrates, leading to superior viewing angle behavior. By patterning the color filters on the active substrate, a total combined mask count of five can be achieved. The same dielectric used for the diode (e.g. Si-rich SiNx) can be used for the storage capacitor. By using the IPS mode with color filters on the array, there are no photolithographic patterns on the other plate, eliminating plate-to-plate alignment requirements. By using the color filters as the dielectric between the select lines and the data lines, a low busline cross-over capacitance is obtained, helping to minimize RC delays and allowing large size displays.

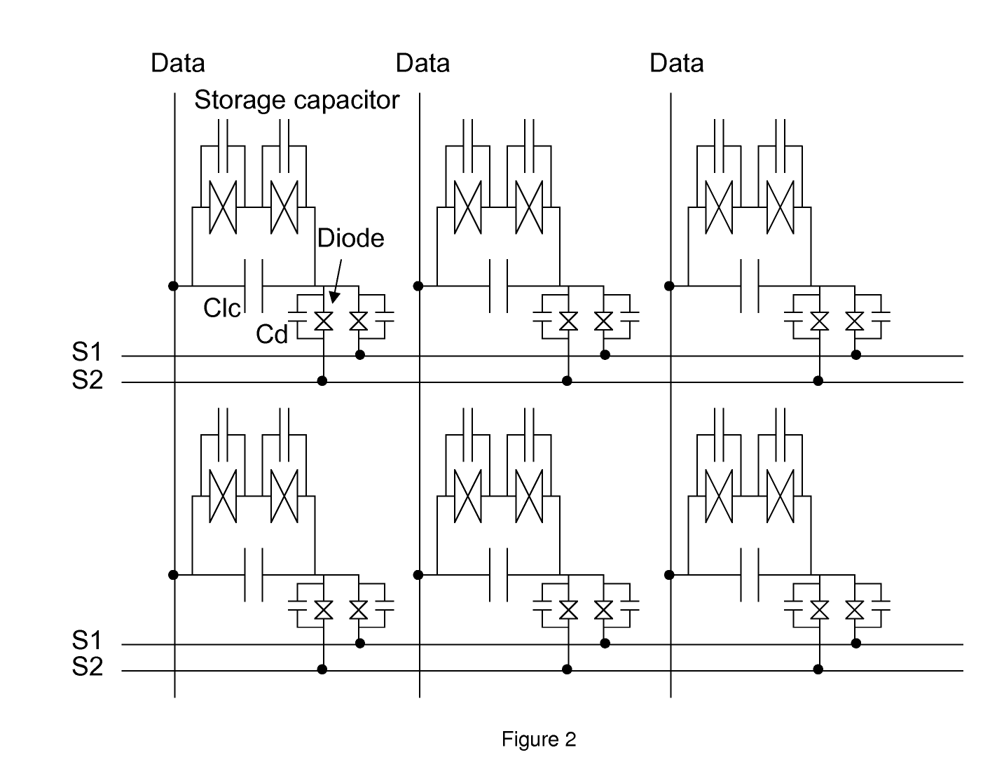

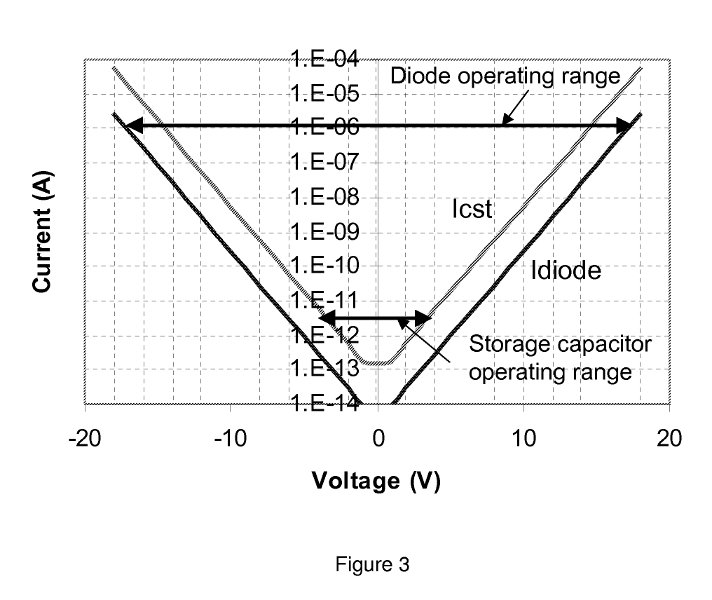

FIG. 2 shows a nonlimiting example of a circuit diagram in accordance with the present disclosure. In this case, both select lines and data lines are on the active matrix array substrate. The storage capacitor has the same stack-up as the diode, but about 20 times larger area. It is split up in two capacitors in series, so that the storage capacitance is about 10× larger than the diode capacitance. When a row is selected, a voltage is applied between the select lines and data lines, of which about 90% can appear across the diodes, because of the capacitance division effect. The diodes start to conduct while the storage capacitor, seeing only about 10% of the voltage, will remain an insulating capacitor, as shown in FIG. 3. During the non-select period, the storage capacitor will see the same voltage as is applied between the lateral electrodes of the IPS mode. This voltage does not exceed about 7 Volts, so that the voltage across each of the split SiNx layers does not exceed 3.5 Volts. At this voltage, the charge retention on the capacitor is excellent, as shown in FIG. 3.

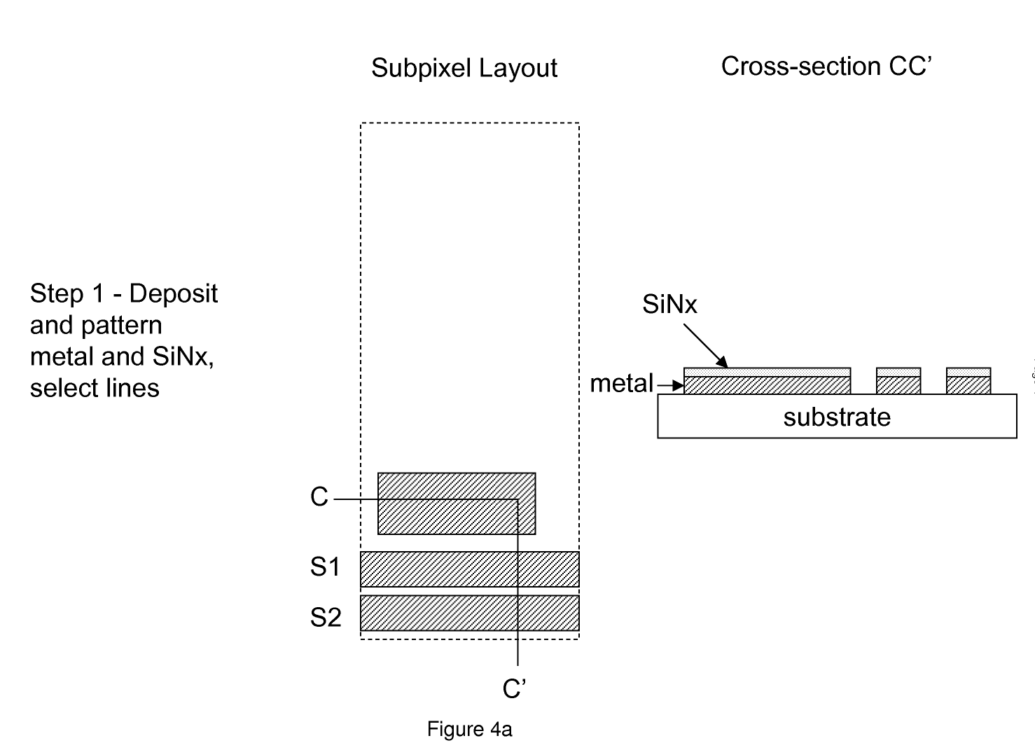

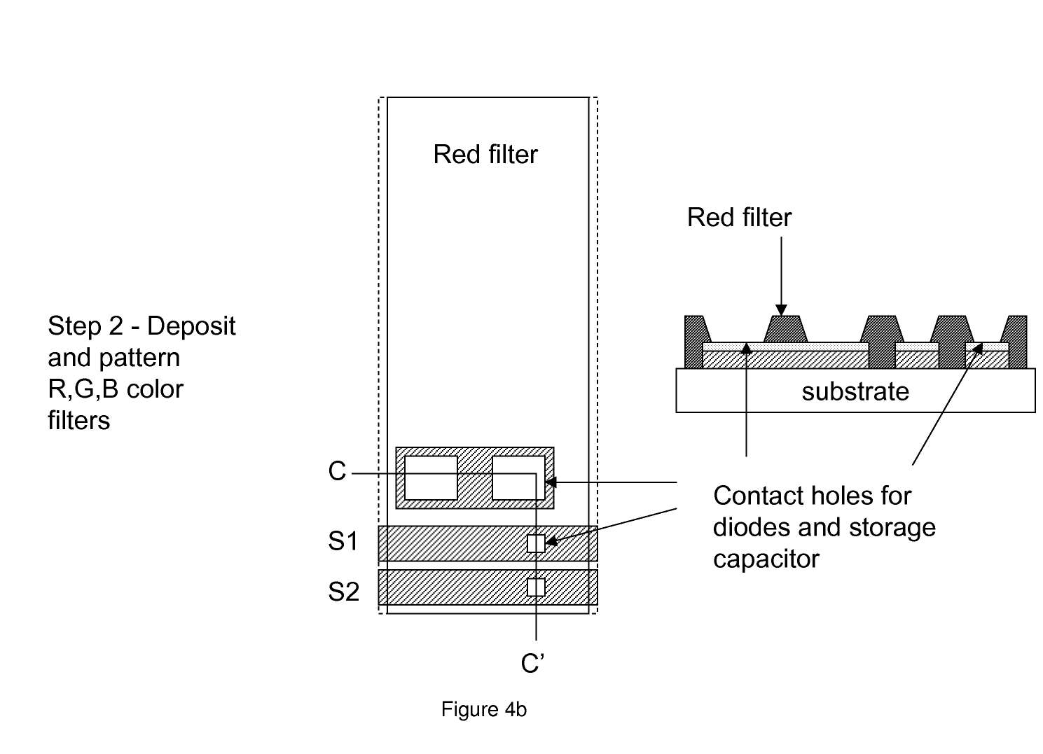

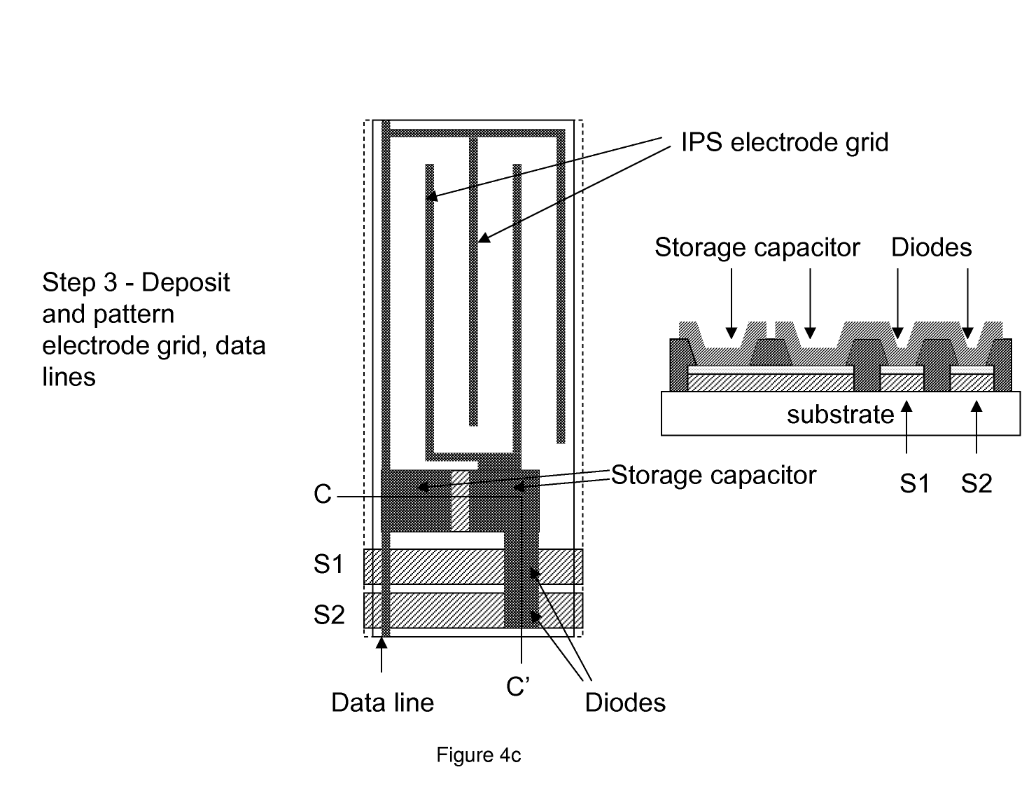

FIGS. 4a-4c show an exemplary cross-section and layout of a subpixel, as it evolves during manufacturing. The select line metal and the dielectric (e.g., SiNx or Diamond-like Carbon) are deposited sequentially. The first mask delineates the select lines with the SiNx on top. Subsequently, with masks 2, 3, and 4, the three color filters R, G and B are deposited and patterned with contact holes (vias) in the location where the diodes and storage capacitors are designed (red is shown in the example). Then, the data line metal is deposited. With the fifth mask the data lines, top electrodes of the diodes and storage capacitors, and the grid for the IPS electrodes are delineated. The areas of the contact holes determine the diode areas and storage capacitor areas.

The top plate of this IPS DSD LCD is simply a glass plate without any pattern. This means that for very large substrate manufacturing, including up to 2 m×2 m or more, there is no critical alignment between the active substrate and the top substrate.

The simple process for IPS DSD LCDs can be used in conjunction with a pixel circuit having separate select lines, as well as shared select lines.

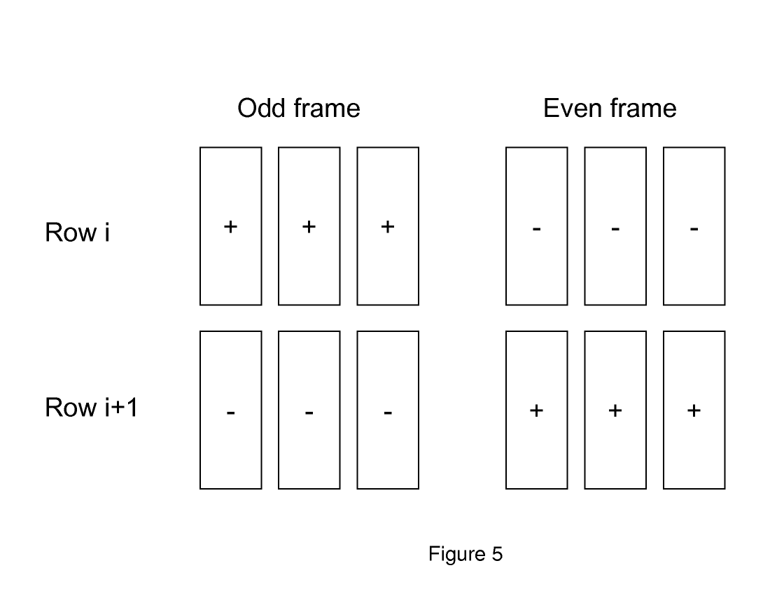

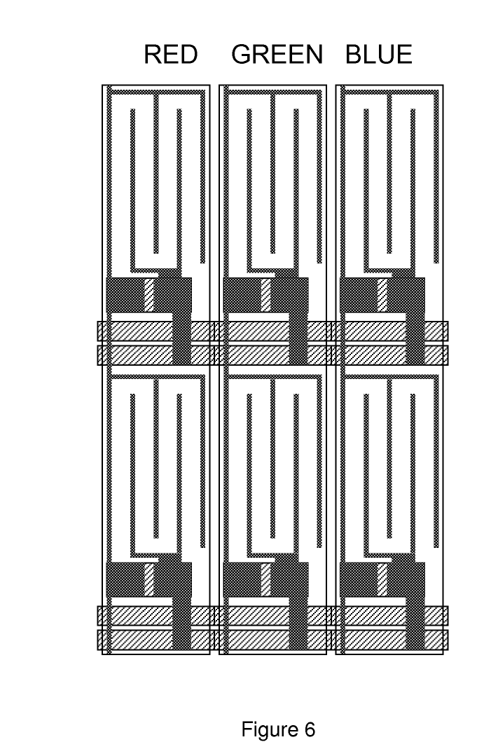

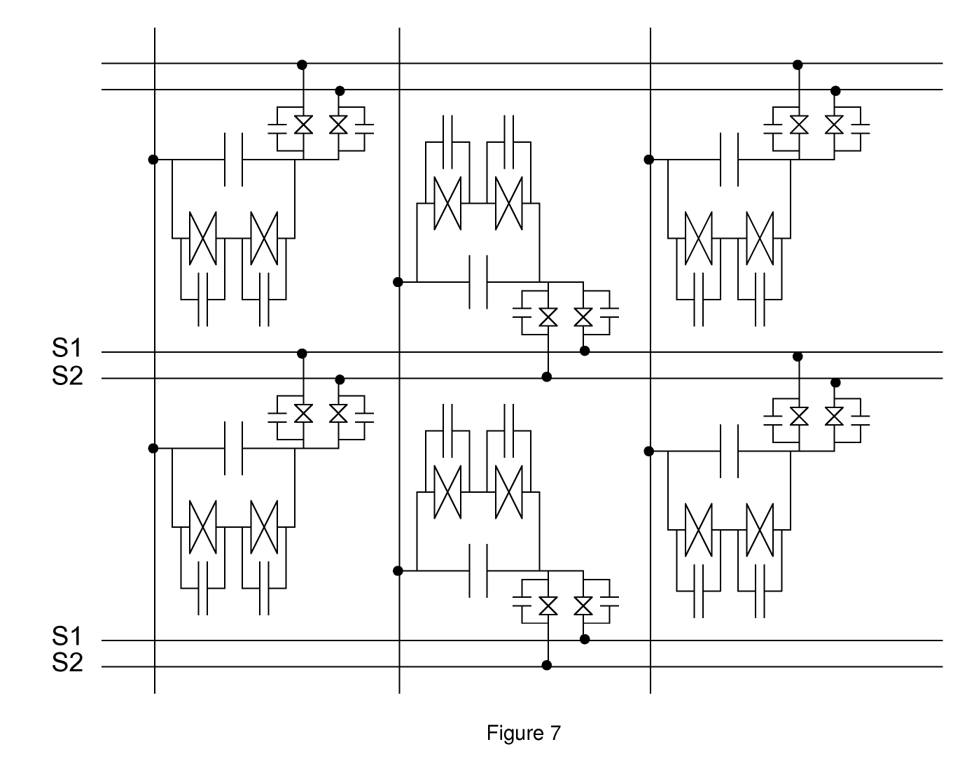

An offset-scan-and-hold driving method was described in U.S. Pat. Nos. 6,225,968 and 6,222,596, which eliminates or minimizes vertical cross-talk and also can improve charge retention on the pixel. This drive method requires line inversion for the data drive. In the pixel layouts of FIGS. 1 and 2, this leads to a positive data polarity of the LC voltage on odd rows and a negative data polarity on even rows for one particular frame time. During the following frame time the polarities are reversed, as shown in FIG. 5. FIG. 6 shows the layout of 6 subpixels in the IPS DSD LCD in this conventional configuration. Line inversion is usually considered to give adequate performance, but dot inversion, in which each pixel has opposite polarity as compared to its direct neighbor, is considered to give better performance in terms of limiting flicker.

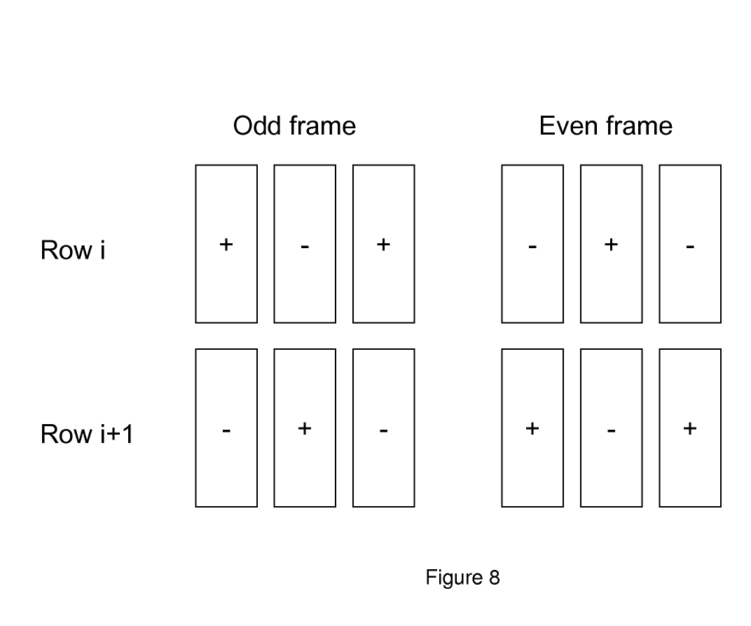

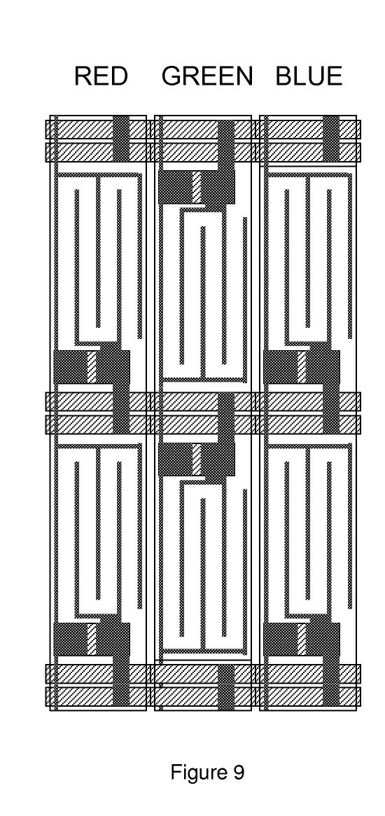

In FIG. 7, a circuit diagram is shown which leads to pseudo dot inversion. Adjacent pixels on one row are patterned on opposite sides of the two select lines S1 and S2, so that they will have opposite data polarity across the LC voltage, although the drive scheme remains line inversion (FIG. 8). FIG. 9 shows the layout of 6 subpixels in an IPS DSD LCD with pseudo dot inversion.

To achieve the correct image on the display, one half of all the video data (for alternate pixels) can be delayed by a line time. A line memory latch in the data driver or some simple image processing in the controller circuitry of the display can facilitate such a delay.

In some embodiments, the diode and storage capacitor areas can be determined by the contact hole size in the color filters. The process can be optimized to obtain high quality diodes in this process; however, there may be an issue with reproducibility and consistency of the diode characteristics, because the top surface of the SiNx layer is exposed to many processing steps. In addition, the patterning of the color filter may leave some residue in the contact hole areas. These two process issues may lead to poorly defined interface between the SiNx layer and the top metal contact to the diode.

The below described embodiments are meant to address this issue, and also to make the diode process stack compatible with high throughput large scale manufacturing.

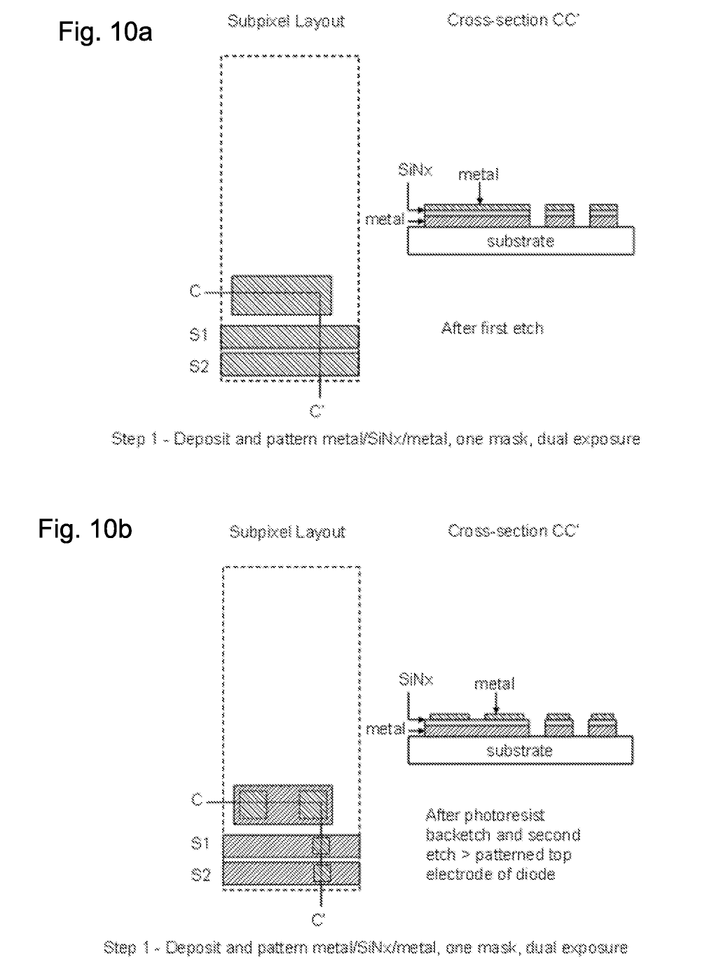

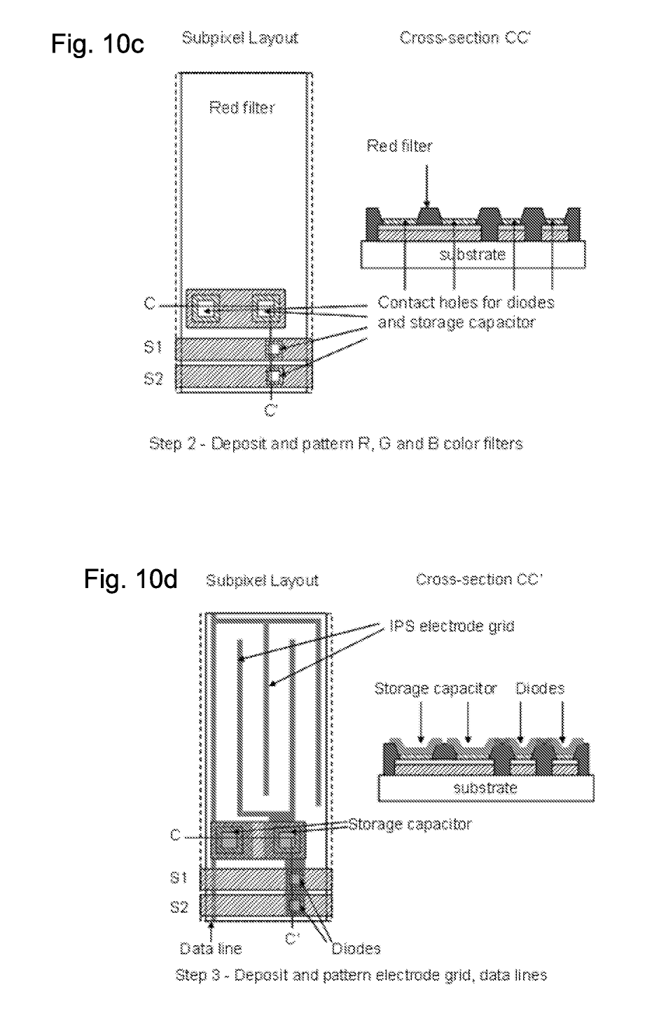

An additional metal layer can be deposited on top of the SiNx, optionally in the same pumpdown, to obtain a stack of metal-SiNx-metal, with well-defined interfaces between both metals and the SiNx layers (see FIG. 10). The following are examples of potential advantages of this method:
No increase in number of masks;
Well-defined interface between SiNx and both metal electrodes for excellent reproducibility of diode I/V characteristics
Opportunity to deposit the metal/SiNx/metal stack at low cost (e.g., <$1/square foot) on a large scale, such as in high throughput coating lines at glass manufacturers.

In FIGS. 10a-10d an exemplary process sequence is shown. First a metal layer, semi-insulator layer and metal layer are sequentially deposited, optionally in one pump-down to control the interfaces between the SlNx layer and both metals. With the first photo-etching step, the stack can be patterned into two select lines S1 and S2 and a capacitor section. This may be done with a partial exposure step, in which the photoresist in the areas outside the select lines and the capacitor section is fully exposed. Some of the area on the select lines and capacitor section can be partially exposed and some of it can be unexposed. In partially exposed areas, the photoresist can be thinner after development than in areas that are not exposed.

After the select lines and capacitor section are patterned, the photoresist can be ashed (or back-etched) so that the thin resist areas are removed while the thicker resist is not fully removed. With a second metal etch step the top metal can be removed such that only top metal remains in the area of the diodes and the storage capacitor, as shown in the figure.

Subsequently, the red, green and blue color filters can be patterned with contact holes on top of the diode and storage capacitor areas.

Finally, the top metal can be deposited and patterned into data lines, interconnects for the diodes and storage capacitors and as an electrode grid for the LC pixels.

Each of the following U.S. Patents and Patent Applications are incorporated by reference for all purposes: 4,731,610; 6,222,596; 6,225,968; 6,243,062; 5,926,236; 6,008,872; 2004/0189885; 2005/0117083; 2005/0105010; 2005/0083283; 2005/0083321.

Although the present disclosure has been provided with reference to the foregoing operational principles and embodiments, it will be apparent to those skilled in the art that various changes in form and detail may be made without departing from the spirit and scope defined in the appended claims. The present disclosure is intended to embrace all such alternatives, modifications and variances. Where the disclosure or claims recite “a,” “a first,” or “another” element, or the equivalent thereof, they should be interpreted to include one or more such elements, neither requiring nor excluding two or more such elements.

1. A liquid crystal pixel circuit, comprising:
first and second select lines;
a pixel node;
a first nonlinear resistive element connected to said first select line and said pixel node;
a second nonlinear resistive element connected to said second select line and said pixel node;
a data line; and
a storage capacitor connected between said data line and said pixel node, wherein the storage capacitor and the nonlinear resistive element share a same dielectric.

2. The pixel circuit of claim 1 having a liquid crystal orientation that is modified by a lateral electric field between electrodes connected to the data line and electrodes connected to the pixel node.

3. The pixel circuit of claim 1, wherein the dielectric between the data line and the select line is a color filter material.

4. The pixel circuit of claim 1, wherein the storage capacitor consists of two series connected capacitors.

5. The pixel circuit of claim 4 in which the area of each of the two series connected capacitors is at least four times the area of the nonlinear resistive element.

6. The pixel circuit of claim 1, wherein the select lines, pixel node, nonlinear resistive elements, data line and storage capacitor are on the same substrate.

7. A liquid crystal display, comprising:
an array of pixels arranged in a plurality of pixel rows and pixel columns;
for each pixel row, a pair of select lines, wherein each pixel of the pixel row is connected to its select lines via nonlinear resistive elements;
for each pixel column, a data line, wherein each pixel of the pixel column is connected to its data line by a storage capacitor; and
wherein, for each pixel, the storage capacitor and the nonlinear resistive elements share the same dielectric.

8. The liquid crystal display of claim 7, wherein a select line for each row of pixels is shared with a select line for at least one adjacent row of pixels.

9. The liquid crystal display of claim 7, wherein the pair of select lines are located at a same side of a pixel row.

10. The liquid crystal display of claim 9, wherein the pixels from a row of pixels are alternatingly connected to adjacent pairs of select lines.
